(19) United States
(12) Patent Application Publication
(10) Pub. No.: US 2004/0034552 A1
(43) Pub. Date: Feb. 19, 2004

(54) Method and system for implementing a business process with a service provisioning model

(75) Inventors: David W. Cole, Austin, TX (US); George A. Geno JR., Wildwood, MO (US); Tedrick N. Northway, Wood River, IL (US); Paul D. Peterson, Round Rock, TX (US); Chris E. Terry, Round Rock, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 10/219,633

(22) Filed: Aug. 15, 2002

(51) Int. Cl. G06F 17/60

(52) U.S. Cl. 705/7

(57) ABSTRACT

A method of implementing a business process with a plurality of technological components is provided. A desired business process is determined, the desired business process comprising a plurality of steps. A model is calculated for the business process, wherein the model comprises an implementation value for each step. An enabling technological component is matched to each step based on the implementation value of the enabling technological component. Computer program product and systems using the method are also provided.

### BACKGROUND OF THE INVENTION

1. Field of the Invention

The present invention relates generally to business systems, and more particularly, to a system and method for provisioning services by integrating business processes with their corresponding technological components.

2. Description of Related Art

Currently, companies have “business processes” that are enabled by multiple, generally heterogeneous, technology components. In addition, a particular business process may span multiple lines of business internally and externally. Thus, the enabling technology components are generally of disparate types and are managed by disparate groups.

For example, a typical loan process may be enabled by the following technology components: several different software applications, several disparate databases, a LAN network, a WAN network, one or more servers and several clients which may vary in type, such as desktops and laptops, or brand. In such a typical process, a technology support group would be available for each application, another group for the LAN component, yet another support group for the WAN component, a support group for the server, and at least one more support group for the clients. Each support group has a focused view on its particular technology component but typically no one group has the overall business process view. That is, no one support group has the ability to view each of the technology component groupings (sometimes called “towers”) in the context of a whole, consolidated business process. Thus, it is often difficult to determine the real or potential impact (the business view) of an incident that has occurred at the component level.

Generally, an end-user sees the business impact of an incident and communicates this impact to the technician but the user does not necessarily have nor require the understanding of the technology component involved with the incident. From the other view, a technician understands the incident that has occurred at the level of the technology component but the technician does not necessarily see the business impact of the incident. This disparity is particularly apparent when an outsourcing organization provides the technology component.

One traditional approach to coordinate disparate technology components uses custom gateway or interface systems. These gateways are not generally designed to integrate data exchange between large numbers of different systems and applications. Furthermore, these gateways are not designed to integrate the technological components with end service business processes, i.e. each gateway is not aware that it is part of a higher level business process.

Other approaches for coordinating disparate technology components are to monitor the types of transactions between different systems and applications. These transaction monitors tend to use rigorous rules to force integrated data exchange between different systems and applications. Also, these monitors are not designed to integrate the technological components with end service business processes. Although transaction monitors are able to monitor specific transactions, they are unable to gauge the overall “health”, of the business process in terms of performance, availability and/or capacity of the system.

The above approaches do not provide a business system that integrates both business and technology components as if the technology components are a single application directly aligned to the metrics of a business process.

The above approaches do not provide a business system that includes integrated underlying technology that is able to reflect the end-user experience of the system.

In addition, the above approaches do not integrate technology components in a manner that reflects the business view of the client.

It would be desirable therefore to provide a method and system of service provisioning that overcomes the above.

### SUMMARY OF THE INVENTION

One aspect of the present invention provides a method of implementing a business process with a plurality of technological components. A desired business process is determined, the desired business process comprising a plurality of steps. A model is calculated for the business process, wherein the model comprises an implementation value for each step. An enabling technological component is matched to each step based on the implementation value of the enabling technological component.

Another aspect of the present invention provides computer program product for implementing a business process with a plurality of technological components. The product includes means for determining a desired business process, means for calculating a model for the business process, wherein the model comprises an implementation value for each step and means for matching an enabling technological component to the step based on the implementation value of the enabling technological component. The product also includes means for running, stopping or re-starting the business process.

Another aspect of the present invention provides a system for implementing a business process with a plurality of technological components. The system includes means for determining a desired business process, means for calculating a model for the business process, wherein the model comprises an implementation value for each step and means for matching an enabling technological component to the step based on the implementation value of the enabling technological component.

The foregoing, and other, features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims in equivalence thereof.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a schematic diagram of one embodiment of a service provisioning system in accordance with the present invention;

FIG. 2 is a schematic diagram of one embodiment of a service-provisioning model in accordance with the present invention;

FIG. 3 is a schematic diagram of another embodiment of a service-provisioning model in accordance with the present invention;

FIG. 4 is a flow diagram of one embodiment of a method of provisioning services in accordance with the present invention;

FIG. 5 is a flow diagram of another embodiment of a method of provisioning services in accordance with the present invention;

FIG. 6 is a schematic diagram of one application of the method of FIG. 5 in accordance with the present invention;

FIG. 7 is a schematic diagram of one application of the method of FIG. 5 in accordance with the present invention;

FIG. 8 is a block diagram of one embodiment of a technological component in accordance with the present invention; and

FIG. 9 is a block diagram of another embodiment of a technological component in accordance with the present invention.

### DETAILED DESCRIPTION OF THE PRESENTLY PREFERRED EMBODIMENTS

Businesses have numerous critical processes, which are enabled by multiple, disparate technologies. In today's IT environment, there is often a support group for each type of technology, each with its own “tower” management platform. In addition, each group has its own management tools typically focused on monitoring a specific subsystem or element within the IT infrastructure, with little or no capability to evaluate how that component actually impacts the business process from an end-to-end perspective, or how the aggregate performance of all the technology components interacting together as a whole are impacting the business process. Because the systems management towers are often very disjointed, complex problems among many interrelated heterogeneous technology components that have a causal relationship may be difficult to quickly identify, often lead to multiple support personnel being needlessly dispatched, and have no business impact context. This is particularly evident in the current event management and business process “view” tools which only consider the “IT severity” of an event as opposed to mapping a particular anomaly to an actual business impact. The following example will help illustrate this concept.

One server must communicate to another server, via a network router, in order to complete a particular business transaction. If the network failed, or went down, from an IT perspective the network event generated by this failure might be “fatal” or completely down. At the network support layer this IT component failure would trigger immediate support attention. However, at the business process layer, the network failure is only “fatal” or fully down if there is a current request for these two systems to communicate. If no one needs the business process at the point of failure then the fact that a network is down is important, but to the business, it is transparent. At the event level of the network failure there is no intelligence to determine whether or not the business process has actually been impacted and will always show “fatal” when it goes down. This means that each IT event must be mapped to a business impact within the context of the business process. The present invention enables this mapping of IT severity to business impact severity.

The present invention provides an end-to-end Business Systems Management (BSM) capability with the focus on integrating the specific IT infrastructure components supporting one, or many, key business processes in to a single end-to-end management platform. In accordance with the present invention, a service-provisioning model creates a template or guide for implementing end-to-end delivery of services and solutions. The service provisioning model not only determines the services, processes, subprocesses and activities that contribute to a given overall business process but also customizes these services, processes, subprocesses and activities. In addition, the service provisioning model of the present invention orders and prioritizes the services, processes, subprocesses and activities and defines the conducting of “Business as Usual” activities and defines the state of the overall business process when the overall process has reached an ongoing, pre-determined, relatively static end state.

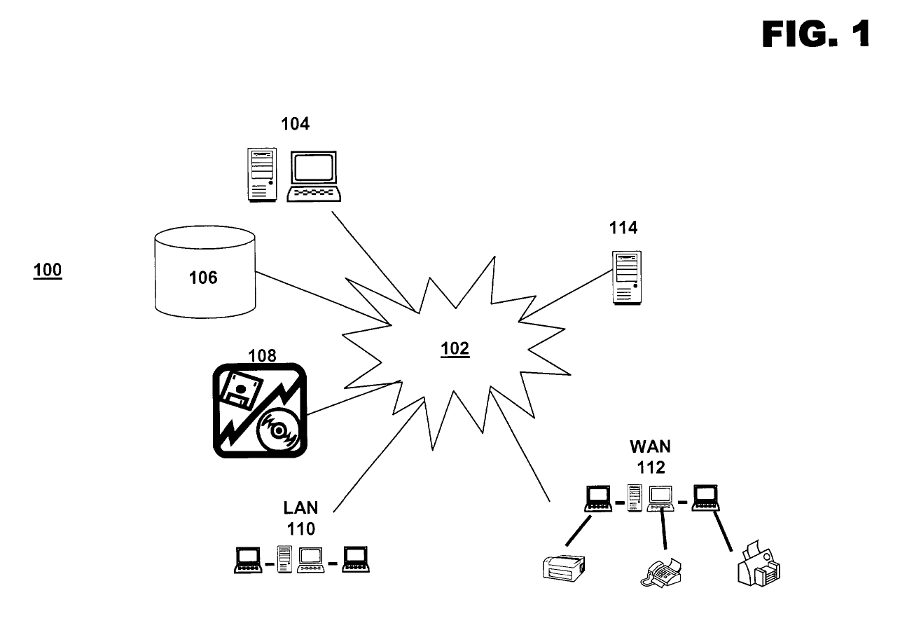

FIG. 1 shows one embodiment of a system of integrated business applications and technology components at 100. System 100 is a system of technology components in which the present invention may be implemented. System 100 includes a service-provisioning model 102, which provides integration between various technology components and business processes connected together within system 100. Service provisioning model 102 may include, for example, hardware or software components that are capable of integrating and deploying templates, guides, communications, briefs, contracts and due diligence tools. For example, service-provisioning model 102 may comprise a customized server with software that calculates a template of instructions and that generates instructions and transmits these instructions to the technology components of system 100. Some examples of software that may be used alone or in combination to implement service-provisioning model 102 include Project Planning Tools, Lotus Notes Team Rooms and various word processing tools.

Service provisioning model 102 may further include connections such as wire, wireless communication links or fiber optic cables for connecting the various technology components and processes and for transmitting Model templates, values, instructions, guides, communications etc. to the technology components of system 100.

System 100 may also include a variety of technology components that are coordinated using service provisioning model 102. For example, FIG. 1 shows an independent client 104, a database 106, software applications 108, a local area network (LAN) 110 and a wide area network (WAN) 112.

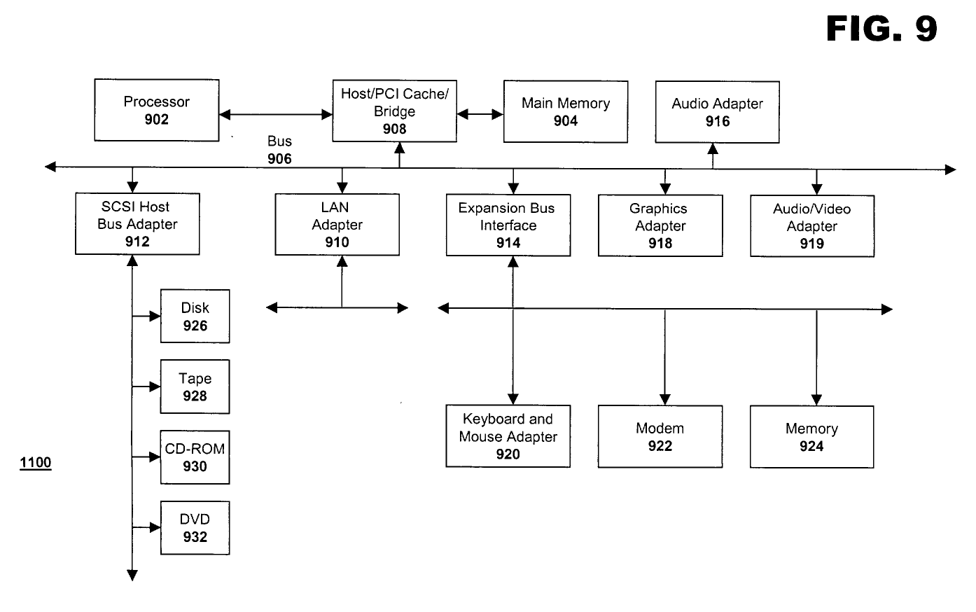

Independent client 104 may be, for example, a data processing system as described in detail below in FIG. 9. Independent client 104 may be a technology component that is capable of providing services to one or more geographic locations based on customer specific priority requirements. Service provisioning model 102 assigns a value to the independent client based on the services which independent client 104 will perform in the overall business process.

Database 106 may be, for example a suitable database for storing data as is well known in the art. Database 106 may be a technology component that is capable of storing information to be retrieved at one or more geographic locations based on customer specific priority requirements. Service provisioning model 102 assigns a value to the database based on the services which database 106 will perform in the overall business process.

Software applications 108 may be, for example, any suitable applications that are capable of accomplishing the objectives of the overall business process as designated by the service-provisioning model 102. The number and type of software applications designated by service provisioning model 102 will depend on the overall business process being modeled. For example, service-provisioning model 102 may use accounting software when modeling an overall billing business process. Alternatively, service-provisioning model 102 may use installation software when modeling an overall installation business process. Service provisioning model 102 assigns a value to the software applications based on the services that software applications 108 would perform in the overall business process.

Local area network (LAN) 110 may be for example a LAN as is well known in the art, which is capable of providing services to one or more geographic locations based on customer specific priority requirements. Service provisioning model 102 assigns a value to the LAN based on the services that LAN 110 will perform in the overall business process.

Wide area network (LAN) 112 may be for example a WAN as is well known in the art, which is capable of providing services to one or more geographic locations based on customer specific priority requirements. Service provisioning model 102 assigns a value to the WAN based on the services that WAN 112 will perform in the overall business process.

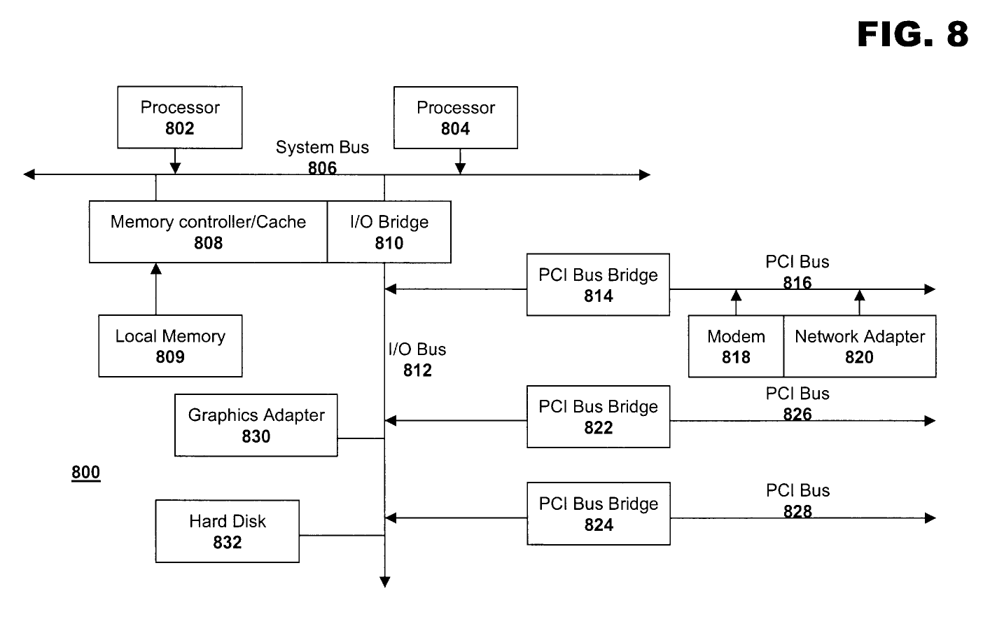

Server 114 may be, for example, a data processing system as described in detail below in FIG. 8. Server 114 may be a technology component that is capable of providing services to one or more geographic locations based on customer specific priority requirements. Service provisioning model 102 assigns a value to the server based on the services which server 114 will perform in the overall business process.

Service provisioning model 102 may be used to describe an overall business process that utilizes all of the components 104, 106, 108, 110, 112, 114. Service provisioning model 102 may then comprise a packaged solution for an overall business process that utilizes independent clients, databases, software applications, LANs, WANs, servers at once, and/or other technology components such as, for example, faxes, PDAs, printers, telephones, etc. The alignment of the services provided by each technology component to each other component is determined by service provisioning model 102.

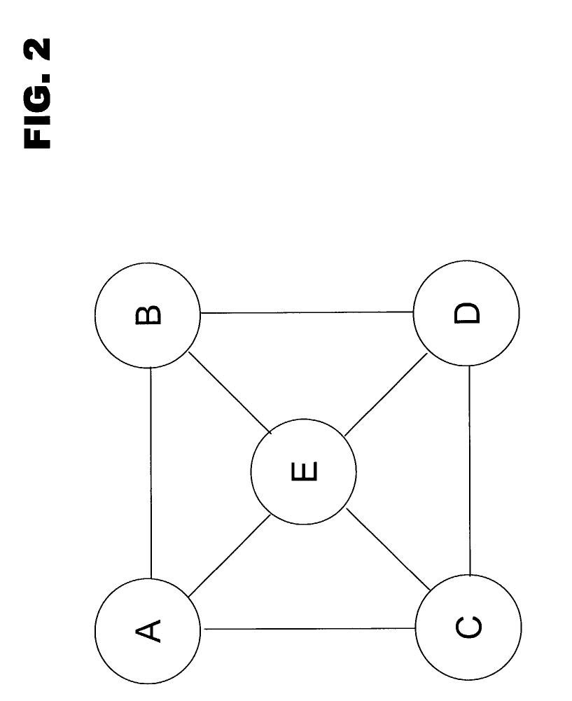

FIG. 2 shows a diagrammatic representation of one embodiment of a model for integrating technology components and the services provided by each technology component in accordance with the present invention at 200.

In the simple example of FIG. 2, which is only illustrative of the minimum level of complexity to be managed by service provisioning model 102, the technology components of FIG. 2 are used to conduct an overall business process, such as creating an invoice. For the purposes of this example only, Subprocess A is the subprocess which processes data for the invoice, Subprocess B is the subprocess which formats the invoice data, Subprocess C is the subprocess which communicates the invoice data to other technology components, Subprocess D is a subprocess which stores the invoice data in a first location and Subprocess E is the subprocess which stores the invoice data in a second location.

Service provisioning model 102 decomposes overall business process 200 into five subprocesses A, B, C, D and E, which in this example are each accomplished by only one step. It should be noted, however, that an overall business process modeled by service provisioning model 102 might generally be several magnitudes more complex than the process seen at 200. For example, one technology component may deliver several subprocesses. Meanwhile, one subprocesses may involve the use of multiple technology components. In addition, one subprocess may be further broken down to a number of applications and activities.

Moreover, although the following examples uses simple implementation values of one integer, the implementation values used by service provisioning model may also be rendered as graphic representations of numerical values, a plurality of numbers, a data stream of numbers, a series of number, graphs, charts, integers and exponential numbers

For each subprocess A, B, C, D, E, service provisioning model 102 assigns a value that indicates the implementation worth of each subprocess in the context of the overall business process. This value may be determined using any suitable algorithm or method of calculation. One method for determining this value is described in related U.S. Pat. application Ser. No.______(Attorney Docket No. AUS9-2000-0315), herein incorporated by reference. The value may be based on the chronology of subprocesses within the context of the overall business process. The value may also be based on the potential for lost revenue resulting from malfunction of a particular subprocess. The value may also be based on the existing or potential impact of a given subprocess to the value chain of the business. The value may also be based on the significance of the subprocesses within the context of the overall business process. For example, some subprocesses are not critical to the overall “health” of the business process. Other subprocesses are critical, e.g., if a critical subprocess is not implemented, it will cause the overall business process to come to a halt. To continue the invoice example above, Subprocess C of communicating the invoice data to other technology components is not critical to the overall “health” of the business process. However, Subprocess A of processing the invoice data is vital to the health of overall business process 200.

Service provisioning model 102 provides a model to each subprocess so that a given subprocess is implemented while being aware of its relationship to the other supporting subprocesses. To continue a simple case scenario, Subprocess A is assigned a critical implementation value of 1, Subprocess B is assigned a value of 2, Subprocess C a value of 3, Subprocess D a value of 4 and Subprocess E a value of 4. The total value for the process 200 is therefore 14. Although the model in this example is a matrix of 5 subprocesses and only one value (14), service-provisioning model 102 may generate a plurality of matrixes and model values depending on the complexity of the overall business process.

Service provisioning model 102 also determines a value for “Business as Usual” activities for overall business process 200. Such a desired value may indicate when the overall business process 200 is in a relatively static end state or is in a “business as usual” state. This desired value may be determined using any suitable algorithm or method of calculation. One method for determining this value is described in related U.S. Pat. application Ser. No.______(Attorney Docket No. AUS9-2002-0315), herein incorporated by reference. The value may be based on the chronology of subprocesses within the context of the overall business process. The value may also be based on the significance of the subprocesses within the context of the overall business process. The value may also be based on the technological components available to provide services to the overall business process. The desired value may indicate the overall model value at which the overall business process can be considered to be implemented at a satisfactory or “business as usual” level. For purposes of the above example only, the overall model value is 10. Although the model in this example is a matrix of 5 subprocesses and only one overall model value (10), Service provisioning model 102 may generate a plurality of matrixes and model values depending on the complexity of the overall business process and the complexity of the desired/“business as usual” state of the overall business process.

Service provisioning model 102 also includes critical implementation values for certain critical processes. When these critical implementation values are not met or are invalid, the overall business process is stopped or is not considered “business as usual” whether or not the standard “business as usual” value is met. For example, Subprocess A is described as a critical subprocess by its critical implementation value. If the value of Subprocess A falls to less than its critical value (in this case 1) and the rest of the subprocesses maintain the same values, the “health” of the overall business process is considered to be stopped even though the “business as usual” value is 10 and the total model value is 14. Service provisioning model 102 may then deploy alternative technology components to continue subprocess A and keep Subprocess A's value at 1. Because Subprocess A is a critical subprocess, Service provisioning model 102 enables subprocesses B, C, D and E to be aware of the model value of Subprocess A.

In the case of non-critical subprocesses, service-provisioning model 102 enables the subprocesses to be aware of each other. For example, Subprocess B's value of 2 could also indicate to Subprocess B that it is followed by Subprocesses C, D and E in chronology of the overall business process. In some cases, for example, where service provisioning model 102 provisions redundancy in subprocesses, service-provisioning model 102 enables the subprocesses to compensate for each other to maintain the overall health of the process 200. For example, Subprocess D may drop its health value to 3 if one of its technology components becomes unavailable. Service provisioning model 102 may then direct components servicing subprocess E to compensate so that subprocess E raises its health value to 5, thereby keeping the overall model “health” of process 200 to 14. Therefore, service-provisioning model 102 enables Subprocess D and Subprocess E to be aware of each other.

Service provisioning model 102's structure enables seamless service. Service provisioning model 102 indicates to each subprocess when any subprocess is called upon by any other subprocess. For example, Subprocess B is not involved when Subprocess E calls upon Subprocess D. However, Subprocess B is aware of the Subprocess D—Subprocess E transaction.

Furthermore each subprocess is aware of the responsibilities of the other subprocesses. For example, Subprocess E is aware that Subprocess B is dependent upon Subprocess A.

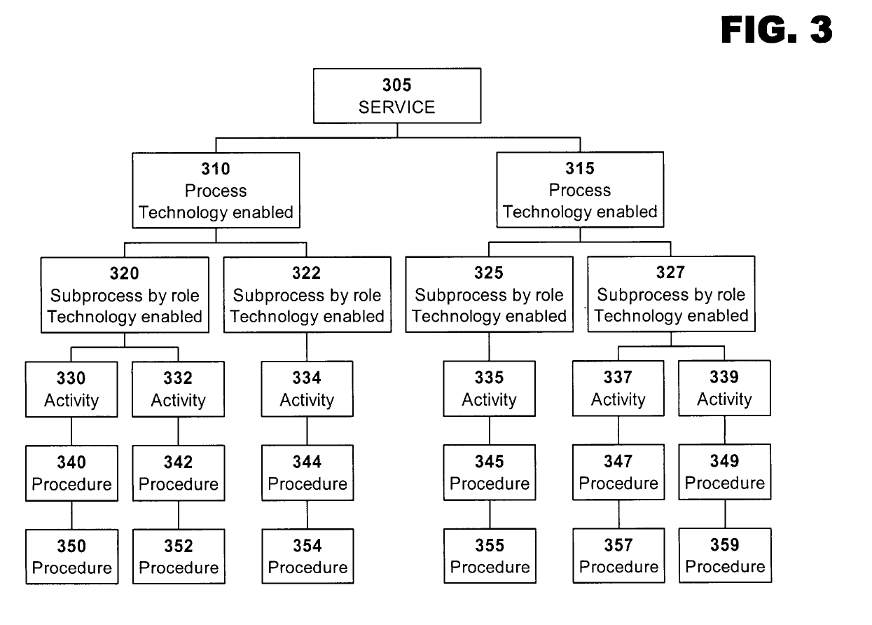

FIG. 3 shows a diagrammatic representation of another embodiment of a model for integrating technology components and the services provided by each technology component in accordance with the present invention at 300.

In FIG. 3, service 305 may be, for example a business service such as Provisioning/Billing process, HelpDesk provisioning, Software Implementation, Event Managing, or Server Building.

One or more processes, having enabling technologies, 310, 315 are available to enable service 305. For example, if overall business service 305 provides a provisioning/billing service to a client, the processes could be a provisioning process 310 and a billing process 315. For each of these processes, service provisioning model 102 assigns a value which enables each process to be aware of its place in the overall business process and also to be aware of the place other processes have in the overall business process. In one embodiment of the service-provisioning model 102, the model may take the form of a matrix or tree of related technologies with corresponding implementation values, much like the tree shown in FIG. 3. The value assigned to each process may depend, for example, on the process 310's relationships to overall service 305 and to complementary process 315. The value may be calculated using any suitable algorithm or calculation, such as, for example, the method described in related U.S. Pat. application Ser. No.______(Attorney Docket No. AUS9-2002-0315), herein incorporated by reference.

One or more subprocesses 320, 322 and 325, 327 are used to achieve processes 310, 315. In the embodiment of FIG. 3, subprocesses 320, 322 are used to achieve process 310 while subprocesses 325, 327 are used to achieve process 315. Some examples of subprocesses include but are not limited to hardware and software procurement, server build and facilities implementation, invoice creation, invoice review and search subprocess technology. To continue the above example, provisioning process 310 comprises taking a customer call 320 and determining if the desired product is available 322. Meanwhile, billing technology 315 comprises order tracking 325 and invoice creation 327.

For each of these subprocesses, service-provisioning model 102 assigns a value that enables each subprocess to be aware of its place in the overall business process and also to be aware of the places that other processes and other subprocesses have in the overall business process. In one embodiment of the service-provisioning model 102, the model may take the form of a matrix or tree of related processes and subprocesses with corresponding implementation values, much like the tree shown in FIG. 3. The value assigned to each subprocess may depend, for example, on the subprocess 320's relationships to overall service 305, to process 310 and to complementary subprocess 322. The value may be calculated using any suitable algorithm or calculation, such as, for example, the method described in related U.S. Pat. application Ser. No.______ (Attorney Docket No. AUS9-2000-0489), herein incorporated by reference.

One or more activities 330, 332, 334, 335, 337, 339 may be controlled by a given subprocess. For example, subprocess 320 controls two activities 330, 332. Meanwhile subprocess 322 controls only one activity 334. However, subprocesses 320, 322 work together to achieve process 310. Furthermore, in the embodiment of FIG. 3, subprocess 325 controls only one activity 335. Meanwhile, subprocess 327 controls two activities 337, 339. However, subprocesses 325, 327 work together to achieve process 315. Some examples of activities include but are not limited to server hardware option selection, server software option selection, order approval, server operating system install and raised floor build, etc.

To continue the above example, provisioning technology 310 comprises taking a customer call 320 and determining if the desired product is available 322. Taking the customer call 320 further comprises the activity 330 of receiving the call and the activity 332 of routing the call. Meanwhile, determining if the requested product is available 322 further comprises the activity 334 of searching an inventory database for the product.

For each of these activities, service provisioning model 102 assigns a value, which enables each activity to be aware of its place in the overall business process and also to be aware of the places that other processes, other subprocesses and other activities hold in the overall business process. In one embodiment of the process, the model may take the form of a matrix or tree of related processes, subprocesses and activities with corresponding implementation values, much like the tree shown in FIG. 3. The value assigned to each activity may depend, for example, on the activity 330's relationships to overall service 305, to process 310, to subprocess 320, to complementary activity 332 and to noncomplementary activity 334. The value may be calculated using any suitable algorithm or calculation, such as, for example, the method described in related U.S. Pat. application Ser. No.______(Attorney Docket No. AUS9-2002-0315), herein incorporated by reference.

One or more procedures 340, 342, 344, 345, 347, 349, 350, 352, 354, 355, 357, 359, are dictated by a given activity. For example activity 330 dictates procedures 340, 350. Alternatively, activity 330 may dictate procedure 340 separately from procedure 350. Meanwhile, activity 332 dictates procedures 342, 352. Activity 334 dictates procedures 344, 354. Activity 335 dictates procedures 345, 355. Activity 337 dictates procedures 347, 357. Activity 339 dictates procedures 349, 359. Some examples of procedures include, but are not limited to server hardware configuration procedures, server software configuration procedures, order escalation procedures, server operating install procedures, and raised floor building procedures.

To continue the above example, taking the customer call 320 further comprises the activity 330 of receiving the call, which may comprise two procedures: a procedure for receiving the call 340 and a procedure for validating the call 350. In addition, the activity of routing the call 332 may also comprise two procedures: a procedure of determining a route for the call and a procedure for actively routing the call along the determined route. Meanwhile, activity 334 of searching an inventory database for the product may also comprise two procedures: a search procedure for finding the product in the database and a report procedure for reporting the search results.

For each of these procedures, service provisioning model 102 assigns a value which enables each procedure to be aware of its place in the overall business process and also to be aware of the places that other processes, other subprocesses, other activities and other procedures hold in the overall business process. In one embodiment of the process, the model may take the form of a matrix or tree of related processes, subprocesses, activities and procedures with corresponding implementation values, much like the tree shown in FIG. 3. The value assigned to each procedure may depend, for example, on the procedure 340's relationships to overall service 305, to process 310, to subprocess 320, to dictating activity 330, to non-dictating activity 332, to complementary procedure 350 and to noncomplementary procedure 342, 352. The value may be calculated using any suitable algorithm or calculation, such as, for example, the method described in related U.S. Pat. application Ser. No.______ (Attorney Docket No. AUS9-2002-0315), herein incorporated by reference.

At any given level of the service-provisioning model 102 described above, one or more technology components enable the process, subprocess, activity or procedure described. The value service-provisioning model 102 determines for each process, subprocess, activity or procedure is determined by the technology component that will enable the process, subprocess, activity or procedure. Thus, the place each process, subprocess, activity or procedure holds in the service-provisioning model 102 is determined by the technology component enabling the process, subprocess, activity or procedure. In the example of FIG. 3, a technology component enables process 310. To continue with the above example, the technology component may be a data processing system such as seen in FIG. 9, with communications capabilities (alternatively the technology component could be a telephone or other calling device). Because the technology component enables the process 310 level of the service-provisioning model 102, the same technology component enables the levels 320, 330, 340, 350 underneath the process level as well as the levels 322, 334, 344, 354 underneath the process level. Thus, the values assigned to the subprocesses 320, 322, activities 330, 332, 334 and procedures 340, 342, 344, 350, 352, 354 may be calculated based on the same technology component as that used to calculate the implementation value for process 310. Alternatively, as stated above, a plurality of technology components may enable one or more of the service provisioning model-provisioned processes, subprocesses, activities or procedures. Thus, the complexity of the model generated by service provisioning model 102 depends on the technology components that enable the processes, subprocesses, activities or procedures as well as the number of levels each technology component enables.

In a second example of a model based on FIG. 3, service 305 may be an event management service. The two processes enabling service 305 may be a provisioning process 310 and an implementation process 315. The subprocesses for process 310 may be software procurement 320 and hardware procurement 322. Software procurement 320 may include the activity 330 of server software option selection using software configuration procedures 340, 350 and the activity 332 of server software installation using software installation procedures 342, 352. Meanwhile, hardware procurement 322 may include the activity 334 of server hardware option selection using hardware configuration procedures 344, 354. Underneath the same service 305, the subprocesses for implementation process 315 may be server build 325 and facilities modification 327. Server build 325 may include the activity 335 of server operating system install using server operating system procedures 345, 355. Meanwhile, facilities modification 327 may include the activity 337 of raised floor building using building procedures 347, 355 and the activity 339 of power service acquisition using power service acquisition procedures 349, 359.

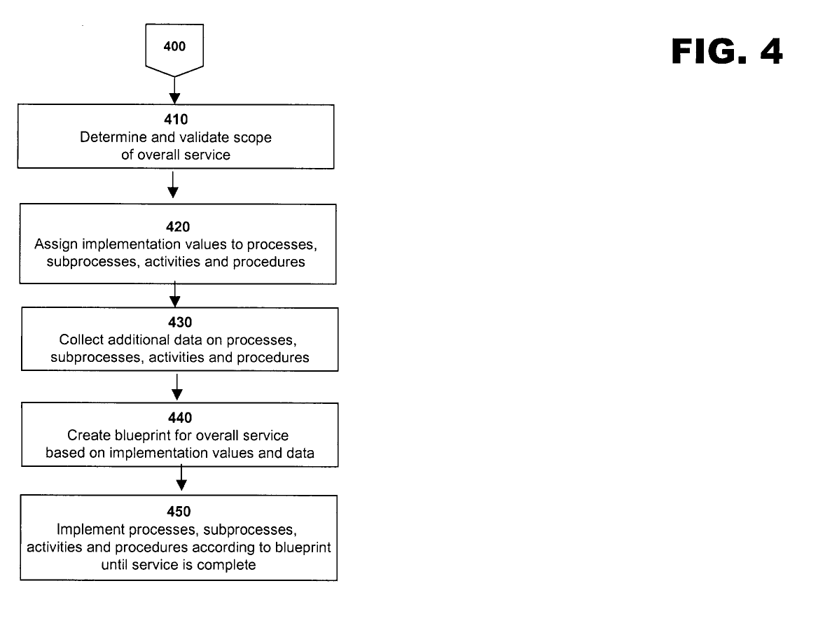

FIG. 4 shows a flow diagram of one embodiment of a method of provisioning services in accordance with the present invention at 400.

In one embodiment of the invention, the method of FIG. 4 is administered by one or more multiple software programs or applications on or in association with the service-provisioning model 102.

As seen at block 410, the scope of overall service is determined and validated. This may be done for example, in consultation with the client, by generating a letter of intent that describes the scope of the service or by generating a database, table or spreadsheet that describes the service. In one embodiment of the invention, the description of the service is input into a pre-designed template that has been customized to generate data for the service-provisioning model 102.

As seen at block 420, implementation values for each of the processes, subprocesses, activities and procedures are calculated as described above and then the values are assigned to the corresponding process, subprocess, activity or procedure. For example, these implementation values may be based on a dimensional analysis that identifies the prioritized service provisioning based upon the processes, subprocesses, activities and procedures being provided. One method of generating these values is described in related U.S. application Ser. No.______(Attorney Docket No. AUS9-2002-0315), herein incorporated by reference.

As seen at block 430, once the initial implementation values have been assigned, additional data is collected on the processes, subprocesses, activities and procedures that have been mapped by model service-provisioning service provisioning model 102. This may be done for example, in consultation with the client and/or by generating a database, table or spreadsheet that describes the service. In one embodiment of the invention, the data is input into a pre-designed template that has been customized to update data for the service-provisioning model 102 that was generated at step 410.

As seen at block 440, a model is then created to describe the desired state of the overall service process. This model is based on the values generated at block 420 and the additional data collected at block 430.

As seen at block 450, the overall service process may then be accomplished by implementing each of the processes, subprocesses, activities and procedures according to the model and under the control of service provisioning model 102, until the overall service process is complete.

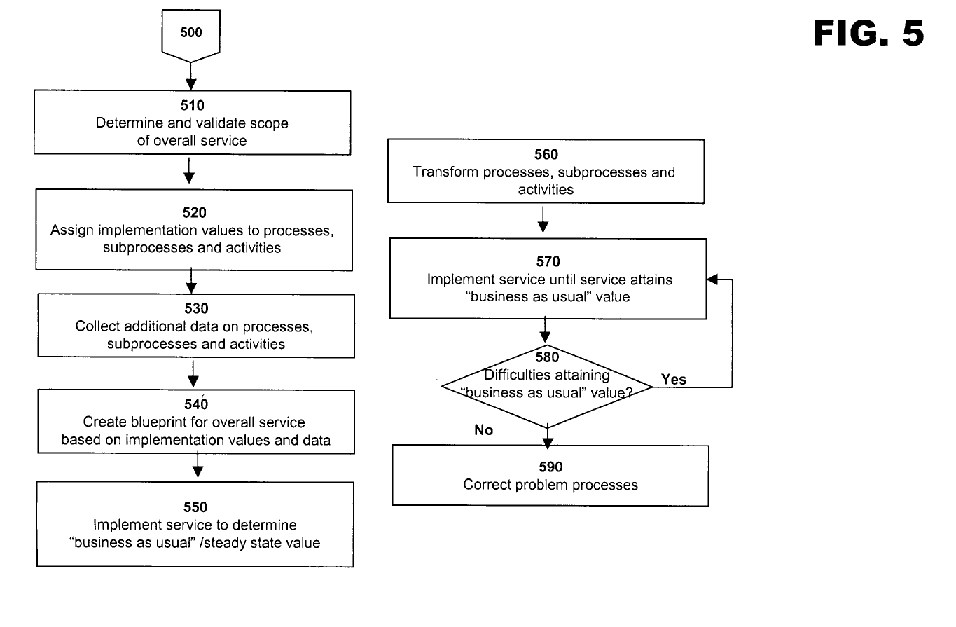

FIG. 5 shows a flow diagram of another embodiment of a method of provisioning services in accordance with the present invention at 500.

In one embodiment of the invention, the method of FIG. 5 is administered by one or more multiple software programs or applications on or in association with the service-provisioning model 102.

As seen at block 510, the scope of overall service is determined and validated. This may be done for example, in consultation with the client, by generating a letter of intent that describes the scope of the service or by generating a database, table or spreadsheet that describes the service. In one embodiment of the invention, the description of the service is input into a pre-designed template that has been customized to generate data for the service-provisioning model 102.

As seen at block 520, implementation values for each of the processes, subprocesses, activities and procedures are calculated as described above and then the values are assigned to the corresponding process, subprocess, activity or procedure. For example, these implementation values may be based on a dimensional analysis that identifies the prioritized service provisioning based upon the processes, subprocesses, activities and procedures being provided. One method of generating these values is described in related U.S. application Ser. No.______(Attorney Docket No. AUS9-2002-0315), herein incorporated by reference.

As seen at block 530, once the initial implementation values have been assigned, additional data is collected on the processes, subprocesses, activities and procedures that have been mapped by model service-provisioning service provisioning model 102. This may be done for example, in consultation with the client and/or by generating a database, table or spreadsheet that describes the service. In one embodiment of the invention, the data is input into a pre-designed template that has been customized to update data for the service-provisioning model 102 that was generated at step 510.

As seen at block 540, a model is then created to describe the desired state of the overall service process. This model is based on the values generated at block 520 and the additional data collected at block 530.

As seen at block 550, the overall service process may then be accomplished by implementing each of the processes, subprocesses, activities and procedures according to the model and under the control service provisioning model 102. This state continues until service-provisioning model 102 is able to determine a “business as usual” or desired value that can be assigned to the overall business process. As discussed above, this desired value might indicate when the overall business process is in a relatively static end state or is in a “business as usual” state.

As seen at block 560, service provisioning model 102 then evaluates the overall business process in view of the value generated at 550 and then transforms the processes, subprocesses, activities and procedures if necessary in order to better enable the attainment of the desired value. This transformation may be accomplished by regenerating the implementation values or by providing instructions to the various enabling technology components that re-distribute the workflows according to the new implementation values. One method of transforming the processes, subprocesses, activities and procedures is described in related U.S. Pat. application Ser. No.______(Attorney Docket No. AUS9-2000-0489), herein incorporated by reference.

As seen at block 570, the overall business process is implemented until the desired value is attained, e.g., until the desired lasting state of the business process is achieved.

As seen at block 580, it may be determined if there are difficulties, such as problematic processes, subprocesses, activities and procedures, which impede attainment of the desired value. If there are such difficulties, the method proceeds to block 590 wherein the problem processes, subprocesses, activities or procedures are further transformed or corrected. This may be accomplished by regenerating the implementation values or by providing instructions to the various enabling technology components that correct the workflows according to the new implementation values. One method of dealing with problem processes, subprocesses, activities and procedures is described in related U.S. Pat. application Ser. No.______(Attorney Docket No.______), herein incorporated by reference.

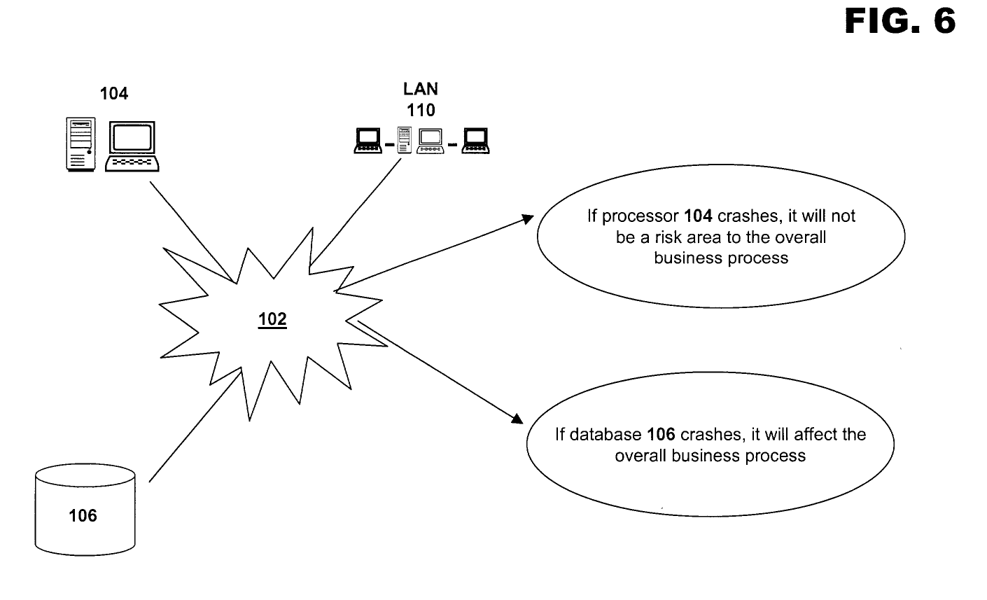

FIG. 6 shows a schematic diagram of one application of model service provisioning system in accordance with the present invention.

As seen in FIG. 6, the model process and system may be used to analyze process components of an overall business process (e.g. processes, subprocesses, activities and procedures) and also to analyze technology components and, from this analysis, determine bottlenecks or risk areas to the overall business process. Returning to the first example of FIG. 3, overall business service 305 may be a provisioning/billing service managed by model service provisioning service-provisioning model 102. In the example of FIG. 6, client 104 is a personal computer, which receives orders from one geographic location. Meanwhile, database 106 is the inventory database. Service provisioning model 102 assesses the effect on the overall business process in order to determine an implementation value for processes, subprocesses, activities and procedures that rely on client 104 and database 106. The implementation values for processes, subprocesses, activities and procedures that rely on client 104 will reflect that client 104 is not a risk area to the overall business process. Because service provisioning model 102 is available to the other components and their corresponding processes, subprocesses, activities and procedures, each of the other components, (in FIG. 6, LAN 110) processes, subprocesses, activities and procedures are aware of exactly how critical client 104 is to the overall business process.

On the other hand, the implementation values for processes, subprocesses, activities and procedures that rely on database 106 will reflect that database 106 is a critical risk area to the overall business process. The value assigned to processes depending on database 106 may be a critical value as described above such that any deviation from the value indicates that database 106 is compromised and that the overall business process is compromised. Alternatively, database 106 may be assigned an implementation value, which indicates the level of importance of database 106 to the overall process. Because service provisioning model 102 is available to the other components and their corresponding processes, subprocesses, activities and procedures, each of the other components, processes, subprocesses, activities and procedures are aware of exactly how critical database 106 is to the overall business process.

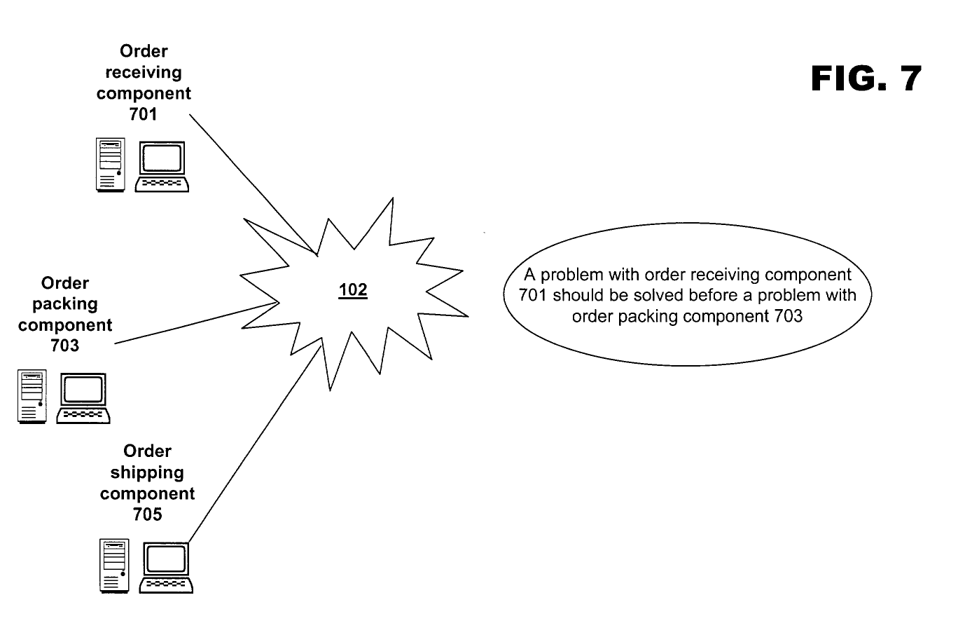

FIG. 7 shows a schematic diagram of another application of model service provisioning system in accordance with the present invention.

As seen in FIG. 6, the model process and system may be used to approach problem diagnosis of technological components from the perspective of the overall business process (e.g. processes, subprocesses, activities and procedures) Returning to the first example of FIG. 3, overall business service 305 may be a provisioning/billing service 310 managed by service provisioning model 102. In the example of FIG. 7, technological components 701, 703 and 705 are three separate servers, each of which manages a different subprocess of provisioning service 310. Server 701 implements the order receiving subprocess, server 703 implements the order packing subprocess, and server 705 implements the order shipping subprocess.

The implementation values for processes, subprocesses, activities and procedures that rely on order receiving component 701 will reflect that server 701 is a critical risk area to the overall business process. The value assigned to the processes dependent on server 701 may be a critical value as described above such that any deviation from the value indicates that server 701 is compromised and that the overall business process is compromised. Alternatively, the processes depending on server 701 may be assigned an implementation value, which indicates the level of importance of server 701 to the overall process. Because service provisioning model 102 is available to the other components and their corresponding processes, subprocesses, activities and procedures, each of the other components, processes, subprocesses, activities and procedures are aware of exactly how server 701 is to the overall business process. In addition, the implementation values assigned to processes dependent on server 701 can indicate that problems with server 701 dependent (order receiving) processes must always be resolved before problems with server 705 dependent (order shipping) processes. Because the implementation values are assigned based on an overall model of the overall business process, even if server 705 is a larger or more complicated server, the model indicates that the priority server in terms of the overall business process is server 701.

In another embodiment of the invention, the model process and system may be used to extend the scope of an overall business service. That is, once the model of the processes, subprocesses, activities and procedures has been laid down, the model may be evaluated for areas where additional processes, subprocesses, activities and procedures may be added. As can be seen from the above examples service-provisioning model 102 may be used to reconcile a previous condition or may be used to create a working process from the ground up.

FIG. 8 is a block diagram of a data processing system in accordance with the present invention at 800. In one embodiment of the invention, data processing system 800 may be implemented as server 114 shown in FIG. 1.

Data processing system 800 may be a symmetric multiprocessors (SMP) system including a plurality of processors 802 and 804 connected to system bus 806. Alternatively, a single processor system may be employed. Memory controller/cache 808 may also be connected to system bus 806. Memory controller/cache 808 may provide an interface to local memory 809. I/O bus bridge 810 may also be connected to system bus 806 and may provide an interface to I/O bus 812. Memory controller/cache 808 and I/O bus bridge 810 may be integrated as depicted or may be separate components.

Peripheral component interconnect (PCI) bus bridge 814 connected to I/O bus 812 may provide an interface to PCI local bus 816. One or more modems may be connected to PCI bus 816. Typical PCI bus implementations will support four PCI expansion slots or add-in connectors. Modem 818 and network 820 may be connected to PCI local bus 816. This connection may be through add-in boards. In one embodiment of the invention, modem 818 and accompanying connections provide communications links to target devices such as network computers. For example, such target devices may be those described above at FIG. 1.

Additional PCI bus bridges 822 and 824 may provide interfaces for additional PCI buses 826 and 828. Additional modems or network adapters may be supported from PCI buses 826 and 828. In this manner, data processing system 800 may allow connections to multiple network computers. A memory-mapped graphics adapter 830 and hard disk 832 may also be connected to I/O bus 812 as depicted, either directly or indirectly.

The components depicted in FIG. 8 may be arranged as shown or in any suitable manner that allows data processing system 800 to function as desired. Additionally, other peripheral devices, such as optical disk drives and the like, may be used in addition to or in place of the components depicted.

FIG. 9 is a block diagram of a data processing system in accordance with the present invention at 900. Data processing system 900 may be client 104 in FIG. 1.

In one embodiment of the invention, data processing system 900 may be a stand-alone system configured to be bootable without relying on a network communication interface. Alternatively, data processing system 900 may also comprise one or more network communication interfaces. Data processing system 900 may also be a personal digital assistant (PDA) device. Data processing system may also take the form of a notebook computer or handheld computer. Alternatively, data processing system 900 may be a kiosk or Web appliance. The processes of the present invention may also be applied to a multiprocessor data processing system.

Data processing system 900 may employ a peripheral component interconnect (PCI) local bus architecture. Although the depicted example employs a PCI bus, other bus architectures such as Accelerated Graphics Port (AGP) and Industry Standard Architecture (ISA) may be used. Processor 902 and main memory 904 may be connected to PCI local bus 906 via PCI bridge 908. PCI bridge 908 may also include an integrated memory controller and cache memory for processor 902. Additional connections to PCI local bus 906 may be made through direct component interconnection or through add-in boards. In one embodiment of the invention, local area network (LAN) adapter 910, SCSI host bus adapter 912, and expansion bus interface 914 are connected to PCI local bus 906 by direct component connection. In contrast, audio adapter 916, graphics adapter 918 and audio/video adapter 919 are connected to PCI local bus 906 by add-in boards inserted into expansion slots. Expansion bus interface 914 may provide a connection for additional components such as, for example, a keyboard and mouse adapter 920, a modem 922 and additional memory 924. A small computer system interface (SCSI) host bus adapter 912 may provide a connection for additional components such as, for example, a hard disk drive 926, a tape drive 928, a CD-ROM drive 930 or a DVD 932. PCI local bus 906 may be any suitable local bus implementation. Typical PCI local bus implementations will support three or four PCI expansion slots or add-in connectors.

In one embodiment of the invention, a software program or application for selecting and managing test systems may run on processor 902. This software program may comprise, for example, components of model service provisioning service provisioning model 102. Instructions from service provisioning model 102 may be located on storage devices such as, for example, hard disk drive 926. These instructions, applications and/or programs may be loaded into main memory 904 for execution by processor 902.

The components of system 900 depicted in FIG. 9 may be arranged as shown or in any suitable manner that allows data processing system 900 to function as desired. Other internal hardware or peripheral devices, such as flash ROM (or equivalent nonvolatile memory) or optical disk drives and the like, may be used in addition to or in place of the components depicted. For example, one embodiment of data processing system 900 may be configured with ROM and/or flash ROM in order to provide non-volatile memory for storing operating system files and/or user-generated data.

While the present invention has been described in the context of a fully functioning data processing system, it will be appreciated that the processes described may be distributed in any other suitable context. For example, the processes described may take the form of a computer readable medium of instructions. The present invention applies equally regardless of the type of signal bearing media actually used to carry out the distribution. Examples of computer readable media include recordable-type medium, such as a floppy disk, a hard disk drive, a RAM, CD-ROMs, DVD-ROMS, and transmission-type media, such as digital and analog communications links, wired or wireless communications links using transmission forms such as, for example, radio frequency and light wave transmissions. The computer readable media may take the form of coded formats that are decoded for actual use in a particular data processing system.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of implementing a business process with a plurality of technological components, comprising:
determining a desired business process, the desired business process comprising a plurality of steps;
calculating a model for the business process, wherein the model comprises an implementation value for each step; and
matching an enabling technological component to the step based on the implementation value of the enabling technological component.

2. The method of claim 1 wherein the model is in a valid state having a majority of implementation values being valid, further comprising:
running the business process.

3. The method of claim 1 wherein the model is in a valid state having at least one implementation value being a valid critical implementation value, further comprising:
running the business process.

4. The method of claim 1 wherein the model is in an invalid state having a majority of implementation values being invalid, further comprising:
stopping the business process.

5. The method of claim 1 wherein the model is in an invalid state having at least one implementation value being an invalid critical implementation value, further comprising:
stopping the business process.

6. The method of claim 4, further comprising:
re-calculating the model when the model is in an invalid state.

7. The method of claim 4, further comprising:
re-starting the business process when the model returns to the valid state.

8. The method of claim 1, further comprising:
assigning the implementation value to the enabling technological component.

9. The method of claim 8 wherein the implementation value is a critical implementation value, indicating that the technological component is a critical component.

10. The method of claim 9 wherein when the critical component is available to the business process, the corresponding critical implementation value is valid.

11. The method of claim 9 wherein when the critical component is unavailable to the business process, the corresponding critical implementation value is invalid.

12. The method of claim 1 wherein the implementation value describes a performance measurement of the enabling technological component.

13. The method of claim 1 wherein the implementation value describes whether the enabling technological component is available to the business process.

14. The method of claim 1 wherein the implementation value describes a capacity of the enabling technological component.

15. Computer program product for implementing a business process with a plurality of technological components, comprising:
means for determining a desired business process, the desired business process comprising a plurality of steps;
means for calculating a model for the business process, wherein the model comprises an implementation value for each step; and
means for matching an enabling technological component to the step based on the implementation value of the enabling technological component.

16. The product of claim 1 wherein the model is in a valid state having a majority of implementation values being valid, further comprising:
means for running the business process.

17. The product of claim 15 wherein the model is in a valid state having at least one implementation value being a valid critical implementation value, further comprising:
means for running the business process.

18. The product of claim 15 wherein the model is in an invalid state having a majority of implementation values being invalid, further comprising:
means for stopping the business process.

19. The product of claim 15 wherein the model is in an invalid state having at least one implementation value being an invalid critical implementation value, further comprising:
means for stopping the business process.

20. The product of claim 19, further comprising:
means for re-calculating the model when the model is in an invalid state.

21. The product of claim 19, further comprising:
means for re-starting the business process when the model returns to the valid state.

22. The product of claim 15, further comprising:
means for assigning the implementation value to the enabling technological component.

23. A system for implementing a business process with a plurality of technological components, comprising:
means for determining a desired business process, the desired business process comprising a plurality of steps;
means for calculating a model for the business process, wherein the model comprises an implementation value for each step; and
means for matching an enabling technological component to the step based on the implementation value of the enabling technological component.
